(19) United States
(12) Patent Application Publication
(10) Pub. No.: US 2010/0110184 A1
(43) Pub. Date: May 6, 2010

(54) ARTICLE MONITORING SYSTEM

(76) Inventors: Takehiko Hanada, Tokyo (JP); Shin Miura, Tokyo (JP); Shigeru Imai, Tokyo (JP)

Correspondence Address: BIRCH STEWART KOLASCH & BIRCH, PO BOX 747, FALLS CHURCH, VA, 22040-0747, US

(21) Appl. No.: 12/532,270

(22) PCT Filed: Mar. 22, 2007
(86) PCT No.: PCT/JP2007/055882

§ 371 Date: Sep. 21, 2009

(51) Int. Cl. H04N 7/18

(52) U.S. Cl. 348/143; 348/E07.085

(57) ABSTRACT

By referring to the tracking result of an article location pinpointing section 14 tracking the articles A, B, and C, there is provided a route watching section 15 that watches the routes along which articles A, B, and C that are to be monitored are traveling, and when the route watched by the route watching section 15 corresponds to an illegal route, an illicit removal determining section 16 determines the illicit removal of article A, B, or C.

### TECHNICAL FIELD

The present invention relates to an article monitoring system for detecting the illicit removal of an article from a shop such as a supermarket or a convenience store.

### BACKGROUND ART

For example, in a shop such as a supermarket or a convenience store, there are not infrequently committed illegal or fraudulent acts such that customers take an article out of the shop without paying therefor.

In order to cope with such illegal activities, there has been developed an article monitoring system detecting the illicit removal of an article by combining a POS system that assigns a different ID to each individual article in the shop to individually manage the articles, and an image monitoring system observing the images of video cameras shooting the interior of the shop (for example, see Patent Document 1).

In the article monitoring system, for instance, when an article A and an article B are exhibited in a showcase in a shop, the image monitoring system analyzes the image of the video camera to judge whether the article removed out of the showcase is the article A or the article B.

Further, in the POS register, it is judged whether the article for which a payment has been made is the article A or the article B by reading the ID assigned to the article.

In the article monitoring system, when the article identified by the image monitoring system corresponds to the article identified by the POS register, the article removal is judged to be a right one; and if the article identified by the image monitoring system does not correspond to the article identified by the POS register, the article removal is judged to be an illicit one.

Patent Document 1: JP-A-2004-171240 (paragraph numbers [0046] to [0056] and FIG. 1)

The conventional article monitoring system is arranged as described above. Thus, if the image monitoring system can correctly discriminate between the articles taken out of the showcase, the illicit removal of an article can be accurately detected. However, there is the following problem: when an article A and an article B resemble each other (e.g., a series of books having a cover similar to each other and snack foods which are similar to each other in package size and package design), even if the image of the video camera is analyzed, it is difficult to judge whether the article taken out from the showcase is the article A or the article B. As a result, the illicit removal of an article cannot be accurately detected.

Further, there is also a problem that the article monitoring system cannot be applied to a shop to which a POS system for individually managing articles has not been introduced.

The present invention has been made to solve the above-mentioned problems, and an object of the present invention is to provide an article monitoring system which can detect the illicit removal of an article even in a shop where a POS system individually managing articles has not been introduced and also can accurately detect the illicit removal of an article even when articles that resemble each other are exhibited in a showcase.

### DISCLOSURE OF THE INVENTION

According to an article monitoring system of the present invention, there is provided a route watching means that watches or catches the route along which an article to be monitored is traveling by referring to the tracking result of an article tracking means for tracking the article, and when the route watches by the route watching section corresponds to an illegal route, an illicit removal determining means determines the illicit removal of an article.

In such a way, even in a shop where a POS system that individually manages articles has not been introduced, the illicit removal of an article can be detected, and further even when articles resembling each other are exhibited in a showcase, the illicit removal of an article can be accurately detected.

### BRIEF DESCRIPTION OF THE DRAWINGS

FIG. 1 is a configuration diagram showing an article monitoring system in accordance with the first embodiment of the present invention.

FIG. 2 is a sequence diagram showing the contents of processing performed when the article monitoring system in accordance with the first embodiment of the present invention makes a judgment on payment for an article.

FIG. 3 is a sequence diagram showing the contents of processing performed when the article monitoring system in accordance with the first embodiment of the present invention determines the illicit removal of an article.

FIG. 4 is an explanatory diagram showing image scanning performed in a small area unit.

FIG. 5 is an explanatory diagram showing a judgment result storing table stored in a judgment result storing section 17.

FIG. 6 is an explanatory diagram showing the judgment result storing table with judgment time stored in the judgment result storing section 17.

### BEST MODE FOR CARRYING OUT THE INVENTION

Embodiments of the present invention will now be described with reference to the accompanying drawings in order to explain the present invention in more detail.

### First Embodiment

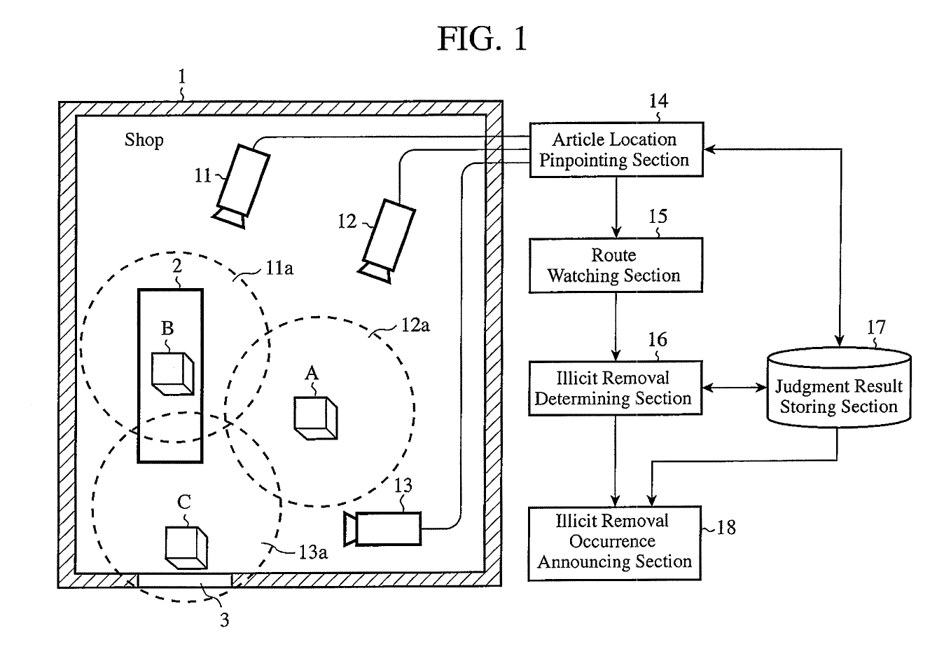

FIG. 1 is a configuration diagram showing an article monitoring system in accordance with the first embodiment of the present invention.

FIG. 1 illustrates an example where the system is monitoring articles A, B, and C present within a shop 1 as objects to be monitored.

In FIG. 1, a video camera 11 is a fixed point camera of which the shot region is denoted by reference numeral 11a, and is shooting a cash register 2, the article B and so on that are present within the shot region 11a.

A video camera 12 is a fixed point camera of which the shot region is denoted by reference numeral 12a, and is shooting the article A present within the shot region 12a.

A video camera 13 is a fixed point camera of which the shot region is denoted by reference numeral 13a, and is shooting a shop exit 3 and the article C present within the shot region 13a.

It should be appreciated that the video cameras 11-13 are assumed to be disposed such that the entire shop 1 is under supervision.

An article location pinpointing section 14 is composed of a semiconductor integrated circuit board where, e.g., an MPU and the like are mounted, and performs the processing of tracking the articles A, B, and C to be monitored that are present within the shop 1. To be concrete, the article location pinpointing section executes the processing of analyzing the images shot by the video cameras 11-13 and pinpointing the locations of the articles A, B, and C.

In this context, the video cameras 11-13 and the article location pinpointing section 14 constitute an article tracking means.

A route watching section 15 consists of a semiconductor integrated circuit board where, e.g., an MPU and the like are mounted, and performs the processing of referring to the results of tracking the articles A, B, and C by the article location pinpointing section 14 and watching the routes along which the articles A, B, and C are traveling.

Note that the route watching section 15 constitutes a route watching means.

An illicit removal determining section 16 is composed of a semiconductor integrated circuit board where, e.g., an MPU and the like are mounted. When the route (e.g., the route along which the article C is traveling) caught by the route watching section 15 corresponds to an illegal route, the section executes the processing of determining the illicit removal of the article C. Namely, when the route watched by the route watching section 15 is a route that has not passed the cash register 2 that is an accounting section, but has passed the shop exit 3, the illicit removal determining section performs the processing of judging the route watched by the route watching section 15 to be an illegal route and determining the illicit removal of the article C.

Hereupon, the illicit removal determining section 16 constitutes an illicit removal determining means.

A judgment result storing section 17 includes a memory that stores a judgment result storing table showing the judgment results of the judgment on payment and the illicit removal judgment made by the illicit removal determining section 16.

An illicit removal occurrence announcing section 18 is composed of a semiconductor integrated circuit board where, e.g., an MPU and the like are mounted. When the illicit removal of an article is determined by the illicit removal determining section 16, the section 18 performs the processing of announcing the occurrence of the illicit removal. To be specific, the illicit removal occurrence announcing section performs the processing of lighting up or blinking a warning light announcing the occurrence of the illicit removal of an article, the processing of sending a mail announcing the occurrence of the illicit removal of an article to the owner of the shop 1 or the company managing the shop 1, and the processing of storing the images shot by the video cameras 11-13.

In this context, the illicit removal occurrence announcing section 18 constitutes an announcing means.

In FIG. 1, it is assumed that each of the article location pinpointing section 14, the route watching section 15, the illicit removal determining section 16, and the illicit removal occurrence announcing section 18, which are the constituent elements of the article monitoring system, is composed of respective dedicated hardware; however, when the article monitoring system is built using a computer, it may be arranged that a program be stored in the memory of the computer, the program having written therein the contents of the processing of the article location pinpointing section 14, the route watching section 15, the illicit removal determining section 16, and the illicit removal occurrence announcing section 18, and that the CPU of the computer run the program stored in the memory.

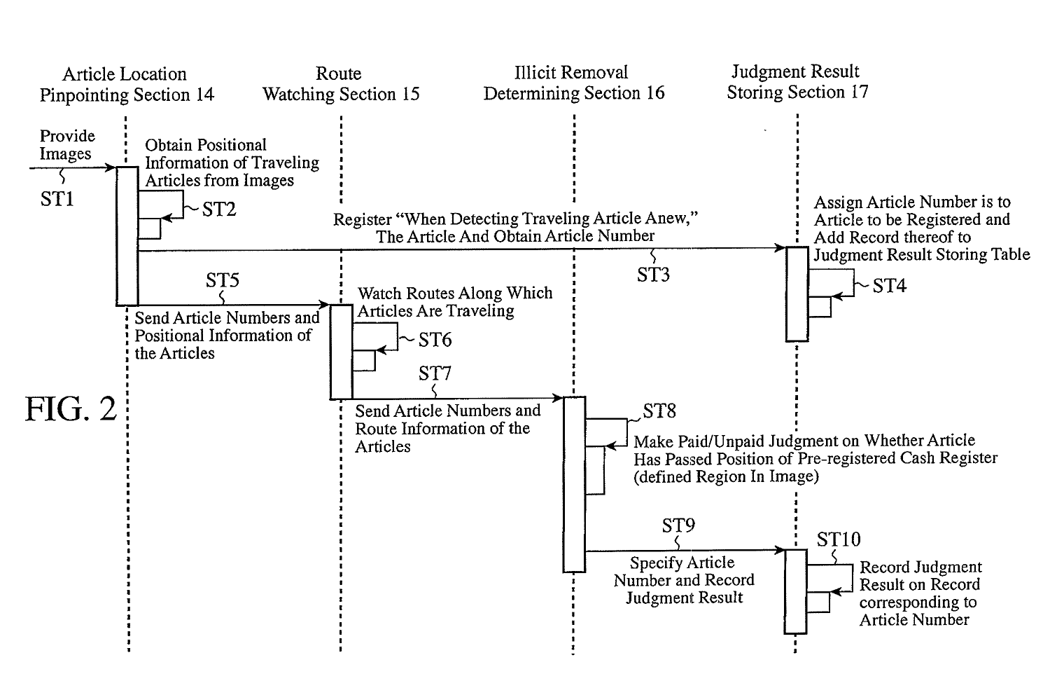

FIG. 2 is a sequence diagram showing the contents of processing performed when the article monitoring system in accordance with the first embodiment of the present invention makes a judgment on payment for an article.

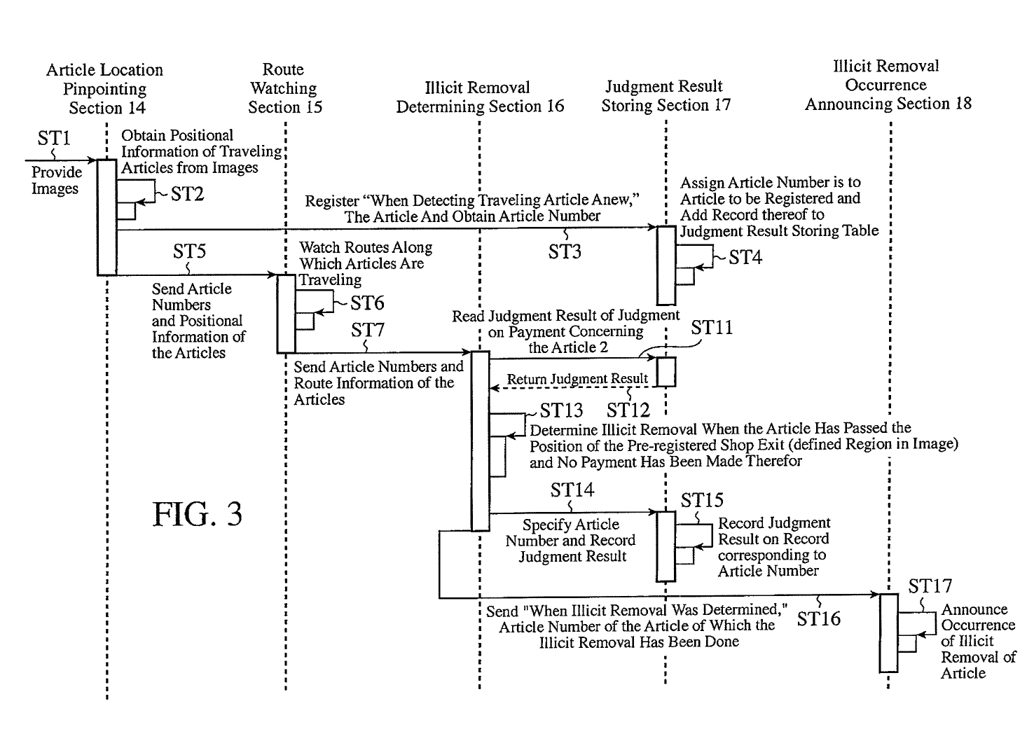

FIG. 3 is a sequence diagram showing the contents of processing performed when the article monitoring system in accordance with the first embodiment of the present invention determines the illicit removal of an article.

Next, an operation thereof will be described below.

In the first embodiment, on the assumption that the articles A, B, and C are concurrently tracked with the articles A, B, and C as objects to be monitored, the article numbers distinguishing between the article A, B, and C are assigned thereto:
Article Numbers:
Article A→1
Article B→2
Article C→3

The video cameras 11-13 continuously or regularly shoot the respective shot regions 11a-13a, and provide the images within the shot regions 11a-13a for the article location pinpointing section 14 (step ST1 in FIG. 2 and FIG. 3).

When receiving the images shot by the video cameras 11-13, the article location pinpointing section 14 analyzes the images within the shot regions 11a-13a to pinpoint the locations of the articles A, B, and C (step ST2).

The locations of the articles A, B, and C show the locations within the shop 1 that is the monitored area, and can be pinpointed from, for example, positional information on the shot regions 11a-13a of the video cameras 11-13 in the shop 1 and the two-dimensional coordinates in the images shot by the video cameras 11-13.

The two-dimensional coordinates in the image can be obtained by, for example, performing image processing like pattern matching.

Specifically, in order to obtain the two-dimensional coordinates in the image, for instance, in the stage where the article monitoring system is initialized, the amount of feature of an article is extracted from the image thereof and stored by executing a principal component analysis and a linear separation method. Alternatively, the image of the article itself is stored.

Subsequently, during the operation, the amount of feature thereof is extracted from the small area of the images shot by the video cameras 11-13 as with the stage where the system is initialized.

Further, a comparison is performed between the amount of feature extracted at the time of initialization and the amount of feature extracted during the operation (or, a comparison is made between the image of the article stored when initializing the system and the small area during the operation), and thereby, the determination is made of the amount of feature of what small area in the plurality of small areas in the images shot by the video cameras 11-13 during the operation conforms with the amount of feature of the article, thus obtaining the two-dimensional coordinates in the image.

The selection of the small areas as objects to be compared is performed as described hereinafter to perform an image scan in a small area unit.

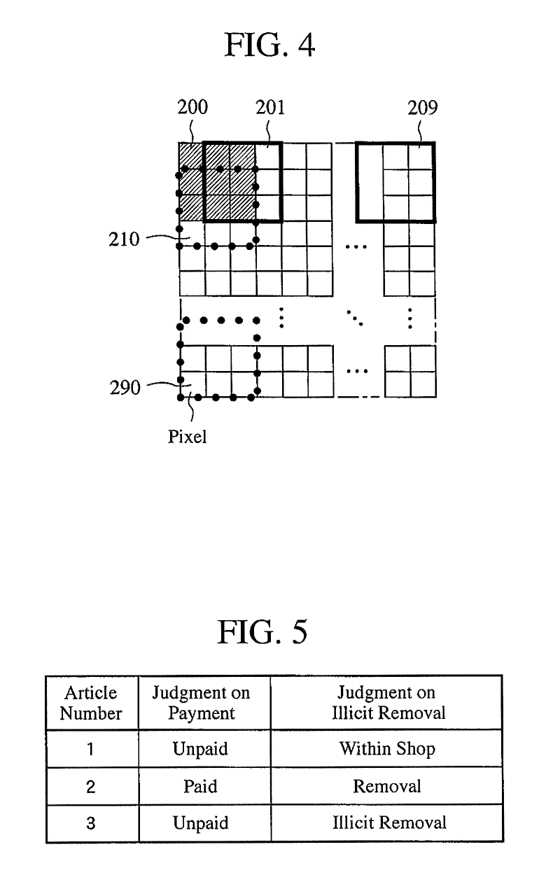

FIG. 4 is an explanatory diagram showing image scanning performed in a small area unit.

In the example shown in FIG. 4, it is arranged that the small areas be selected one by one while shifting the small area consisting of 3×3 pixels horizontally or vertically by one pixel, to perform the comparison processing.

More specifically, the leftmost and topmost small area 200 in the image is first selected, and then small area 201 positioned shifted right by one pixel is selected.

Thereafter, similarly, small areas positioned shifted right by one pixel are selected one by one, and a small area 209 positioned shifted right by X pixels from a small area 200 is selected.

Then, a small area 210 positioned shifted down by one pixel from the small area 200 is selected, next, small areas positioned shifted right by one pixel are selected one by one, and the small area positioned shifted right by X pixels from the small area 210 is selected.

Finally, a small area 290 positioned shifted downward by Y pixels from the small area 200 is selected; subsequently, small areas positioned shifted right by one pixel are selected one by one, and the small area positioned shifted right by X pixels from the small area 290 is selected, to thereby cover the entire image.

Note that when the article location pinpointing section 14 pinpoints the locations of the articles A, B, and C, if a small area having a similar image pattern is travelling, the article location pinpointing section regards the travel of the small area as the one of an article and tracks the travel thereof.

At that time, when a plurality of the articles A, B, and C each having a similar image pattern as in the case they are similar articles are tracked, there is a possibility that a replacement between the articles occurs; however, if all the articles A, B, and C can be tracked until the point in time when those articles are taken out from the shop 1, the illicit removal of an article can be detected; thus, it doesn't matter whether the articles are replaced or not at the time of tracking.

Herein, the following article monitoring system is discussed: the amount of feature of an article is extracted from the small area of the image thereof by executing a principal component analysis and a linear separation method; however, it may be arranged that information of the bar cord type be read as the amount of feature of an article.

It should be noted that in the first embodiment the amount of feature of an article and the image thereof itself are arranged to be stored; however, they are not stored with the goal of individually managing the articles, but they are stored in order to judge whether or not the object shot in the image during the operation is the article to be monitored.

When the section pinpoints the locations of the article A, B, and C as discussed above, the article location pinpointing section 14 sends the article numbers of the articles A, B, and C, and the positional information showing the locations of the articles A, B, and C to the route watching section 15 (step ST5 in FIG. 2 and FIG. 3).

However, when the article location pinpointing section 14 detects a new article as a target to be monitored, in addition to the articles A, B, and C as already registered, the section 14 assigns an article number to the new article in order to register the new article, and adds a new record (a record relating to a new article number) to the judgment result storing table of FIG. 5 that is stored in the judgment result storing section 17 (step ST3 and ST4 in FIG. 2 and FIG. 3).

When the route watching section 15 receives the article numbers of the articles A, B, and C and the positional information showing the locations of the articles A, B, and C from the article location pinpointing section 14, the section accumulates the article numbers and the positional information therein.

Moreover, the route watching section 15 grasps the change in the positions of the articles A, B, and C from past to present by referring to the article numbers and the positional information to be accumulated therein, and thereby watches the routes along which the articles A, B, and C are travelling (step ST6 in FIG. 2 and FIG. 3).

When the route watching section 15 watches the routes along which the articles A, B, and C are travelling, the section communicates the article numbers of the articles A, B, and C, and the route information showing the routes along which the articles A, B, and C are travelling to the illicit removal determining section 16 (step ST7 in FIG. 2 and FIG. 3).

When the illicit removal determining section 16 receives notice of the article numbers of the articles A, B, and C and the route information showing the route along which the articles A, B, and C are traveling from the route watching section 15, the section 16 refers to the article numbers and the routing information to judge whether or not the route along which each of the articles A, B, and C is traveling corresponds to an illegal route.

To be more specific, in the case where the article A, B, or C has passed the shop exit 3 without passing the cash register 2 that is an accounting section, there is a high possibility that the article has been taken out without making a payment therefor; thus, the illicit removal determining section 16 first judges whether the article A, B, or C has passed the cash register 2 that is an accounting section, and thereby judges whether the payment therefor has been made (step ST8 in FIG. 2).

In other words, the illicit removal determining section 16 judges whether the route along which the article A, B, or C is traveling includes the position (a defined region in the image) of the cash register 2 that is an accounting section, thereby judges whether the article A, B, or C has passed the cash register 2 that is an accounting section; further, in the case where the article A, B, or C has passed the cash register 2, it judges that the payment has been made, while in the case where the article A, B, or C has not passed the cash register 2, it judges that no payment has been made.

After making a judgment on payment as discussed above the illicit removal determining section 16 communicates the article numbers of the articles A, B, and C and the judgment results of judgment on payment to the judgment result storing section 17 (step ST9 in FIG. 2).

After receiving notice of the article numbers of the articles A, B, and C and the judgment results of judgment on payment from the illicit removal determining section 16, The judgment result storing section 17 records each of the judgment results of judgment on payment on the record of the judgment result storing table, which corresponds to each of the article numbers (step ST10 in FIG. 2).

Subsequently, the illicit removal determining section 16 obtains the judgment results of judgment on the payment for the articles A, B, and C from the judgment result storing table stored in the judgment result storing section 17 (step ST11 and ST12 in FIG. 3).

After obtaining the judgment results of judgment on the payment for the articles A, B, and C, the illicit removal determining section 16 refers to the judgment results of judgment on the payment to specify an article for which no payment is made.

In the example shown in FIG. 5, the article A of which the number article is “1” and the article C of which the number article is “3” are the articles for which no payment has been made.

The illicit removal determining section 16 refers to the article numbers of the articles A, B, and C and the route information showing the routes along which the articles A, B, and C are traveling communicated from the route watching section 15 to judge whether or not the articles A, B, and C have passed the shop exit 3.

Specifically, the illicit removal determining section 16 judges whether the route along which the article A, B, or C is traveling includes the position (a defined region in the image) of the shop exit 3, and thereby judges whether the articles A, B, or C has passed the shop exit 3.

The illicit removal determining section 16, if the articles A, B, and C are articles for which payments have not been made and further the articles A, B, and C have passed the shop exit 3, judges that the route along which each of the articles A, B, and C is traveling is an illegal route to determine the illicit removal of the articles A, B, and C (step ST13 in FIG. 3).

For example, the illicit removal determining section 16, when the articles B and C have passed the shop exit 3, determines that the taking out of the article B is a legal one since a payment for the article B has been made; however, the section determines that the taking out of the article C is an illegal one since no payment has been made for the article C.

Note that though the article A is an article for which no payment has been made, the article is not determined to be an illegally taken out article, since the article has not passed the shop exit 3.

After determining an illicit removal as discussed above, the illicit removal determining section 16 gives notice of the article numbers of the articles A, B, and C and the judgment result of the illicit removal judgment to the judgment result storing section (step ST14 in FIG. 3).

After receiving notice of the article numbers of the articles A, B, and C and the judgment result of illicit removal judgment from the illicit removal determining section 16, the judgment result storing section 17 records the judgment result of illicit removal judgment on the record of the judgment result storing table, which corresponds to each of the article numbers (step ST15 in FIG. 3).

After determining the article of which the illicit removal has been done, the illicit removal determining section 16 gives notice of the article number thereof to the illicit removal occurrence announcing section 18 (step ST16 in FIG. 3).

When receiving notification about the article number of the article of which the illicit removal has been done from the illicit removal determining section 16, the illicit removal occurrence announcing section 18 announces the occurrence of the illicit removal (step ST17 in FIG. 3).

To be specific, the illicit removal occurrence announcing section 18 refers to the judgment result storing table stored in the judgment result storing section 17 to recognize the article (e.g., the article C) of which the illicit removal has been done from the article number sent from the illicit removal determining section 16, and lights up (or blinks) a warning light announcing the occurrence of the illicit removal of the article C.

Alternatively, the section 18 sends a mail announcing the occurrence of the illicit removal of the article C to the owner of the shop 1 or the company managing the shop 1.

Further, the illicit removal occurrence announcing section 18 stores in a file the images shot by the video cameras 11-13 at the very time when the illicit removal of the article C occurred.

It should be noted that the illicit removal occurrence announcing section 18 may transfer the file having the image stored therein to other arbitrary systems by using a protocol such as an FTP (File Transfer Protocol).

As is apparent from the above discussion, in accordance with the first embodiment, there is provided the route watching section 15 that watches the routes along which the articles A, B, and C as objects to be monitored are traveling by referring to the tracking result of the article location pinpointing section 14 tracking the articles A, B, and C; when the route watched by the route watching section 15 corresponds to be an illegal route, the illicit removal determining section 16 determines the illicit removal of the article A, B, or C. In this way, the illicit removal of an article can be detected even in a shop where a POS system individually managing articles has not been introduced, and further the illicit removal of an article can be accurately detected even when articles resembling each other are exhibited in a showcase.

Moreover, in accordance with the first embodiment, when the route watched by the route watching section 15 is a route that has not passed the cash register 2 that is an accounting section but has passed the shop exit 3, the route watched by the route watching section 15 is judged to be an illegal route or an equivalent, and thereby, the illicit removal of an article is determined. In this way, the illicit removal of an article can be detected without introducing a POS system individually managing articles.

Furthermore, in accordance with the first embodiment, when the illicit removal of an article is determined by the illicit removal determining section 16, the occurrence of the illicit removal is announced. In this way, for instance, the owner, the clerk, or the like of the shop 1 can promptly become aware of the occurrence of the illicit removal.

### Second Embodiment

In the first embodiment, the following article monitoring system is discussed: the article location pinpointing section 14 analyzes the images shot by the video cameras 11-13 to pinpoint the locations of the articles A, B, and C; however, it may be arranged that three-dimensional coordinates showing the three-dimensional position of an article be estimated from two-dimensional coordinates in the images shot by two or more video cameras.

In this connection, the three-dimensional coordinates of an article can be obtained from the two-dimensional coordinates of the article in two or more images shot from different directions by using the three-dimensional coordinates, the directions, and the view angles of previously prepared cameras.

A publicly known TSAI method or the like can be used as a technique for easily obtaining the three-dimensional coordinates, the direction, and the viewing angle of a camera.

### Third Embodiment

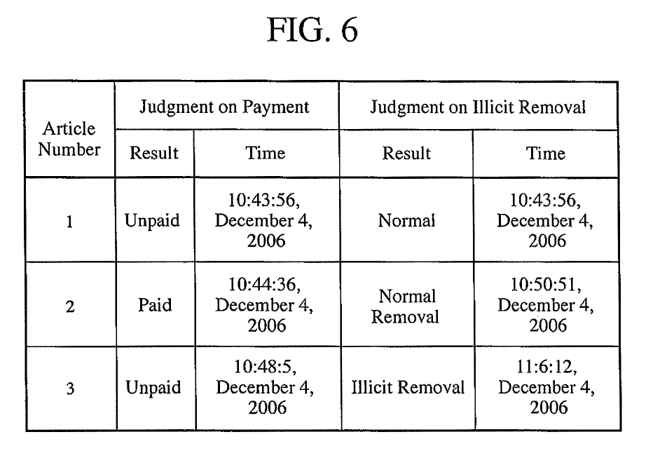

In the first embodiment, the following article monitoring system is discussed: the illicit removal determining section 16 stores the judgment results of the judgment on the payment and the illicit removal judgment in the judgment result storing table (see FIG. 5); however, as shown in FIG. 6, it may be arranged that when the section 16 stores the judgment results of the judgment on the payment and the illicit removal judgment in the judgment result storing table, the illicit removal determining section 16 records the judgment on the payment and the judgment time of the illicit removal judgment in the judgment result storing table.

In that case, the analysis of the act of illicit removal of an article becomes possible by referring to the judgment time recorded in the judgment result storing table.

### INDUSTRIAL APPLICABILITY

As discussed above, the article monitoring system according to the present invention is capable of detecting the illicit removal of an article; thus, the system is suitable for use in, for example, a shop requiring the reduction of an illegal action such that customers take out an article without paying therefor.

1. An article monitoring system comprising:
an article tracking means for tracking an article to be monitored that is present within a predetermined monitored area;
a route watching means for watching the route along which the article is traveling by referring to the tracking result of the article tracking means; and
an illicit removal determining means for determining an illicit removal of the article when the route watched by the route watching means corresponds to an illegal route.

2. The article monitoring system according to claim 1, wherein when the route watched by the route watching means is a route that has not passed an accounting section of a shop but has passed an exit thereof, the illicit removal determining means judges that the route watched by the route watching means corresponds to an illegal route and determines the illicit removal of the article.

3. The article monitoring system according to claim 1, wherein an announcing means for announcing the occurrence of the illicit removal of an article is provided when the illicit removal is determined by the illicit removal determining means.

4. article monitoring system according to claim 1, wherein the article tracking means is composed of a video camera for shooting an article to be monitored and an article location pinpointing section for analyzing the image shot by the video camera to pinpoint the location of an article.

5. The article monitoring system according to claim 4, wherein the article location pinpointing section analyzes the images shot by a plurality of video cameras to pinpoint the three dimensional position of an article.
